(19) United States
(12) Patent Application Publication
(10) Pub. No.: US 2026/0285635 A1
(43) Pub. Date: Sep. 24, 2026

(54) POSITIONING DEVICE, STACKING DEVICE, AND STACKING METHOD FOR REPEATING COMPONENTS OF A CELL STACK FOR BATTERY CELLS OR FUEL CELLS

(71) Applicant: GROB-WERKE GmbH & Co. KG, MINDELHEIM (DE)

(72) Inventor: Tim JANUSCH, ERKHEIM (DE)

(21) Appl. No.: 18/881,103

(22) PCT Filed: Jul. 4, 2023
(86) PCT No.: PCT/EP2023/025310

§ 371 Date: Jan. 3, 2025

(30) Foreign Application Priority Data
Jul. 7, 2022 (DE) 10 2022 00 2476.4

(51) Int. Cl. B65H 31/38; H01M 8/2404; H01M 10/04

(52) U.S. Cl. CPC B65H 31/38; H01M 8/2404; H01M 10/0404; B65H 2301/421; B65H 2301/4222; B65H 2404/741; B65H 2701/19

(57) ABSTRACT

A positioning device and a stacking device for positioning repeating components of a cell stack for battery cells or fuel cells, wherein repeating components are placed on top of one another. Also a stacking method for forming a cell stack for a battery cell or fuel cell. At least one elastic element is provide such that it decelerates a repeating component inserted into the positioning device if, when inserted into the positioning device transversely to the plane of the repeating components, one edge of the inserted repeating component strikes the at least one elastic element; and at least one positioning element which vibrates by vibration generators in such a way that the at least one edge of the inserted repeat component is aligned with the corresponding edges of the repeating components already inserted.

### CROSS-REFERENCES TO RELATED APPLICATIONS

This application claims the benefit of International Application Number PCT/EP2023/025310 filed on Jul. 4, 2023, and of the German patent application No. 10 2022 002 476.4 filed on Jul. 7, 2022, the entire disclosures of which is incorporated herein by way of reference.

### FIELD OF THE INVENTION

The invention relates to a positioning device for positioning repeating components of a cell stack for battery cells or fuel cells, which repeating components are to be placed on top of one another. The invention further relates to a stacking device for forming a cell stack for a battery cell or fuel cell from a several repeating components to be placed on top of one another, which stacking device includes such a positioning device. Finally, the invention relates to a stacking method using such a stacking device.

### BACKGROUND OF THE INVENTION

In the field of automated fuel cell production, known as stack assembly, pick-and-place is the primary method used to manufacture a fuel cell stack. The principle of the pick-and-place process is to stack repeating units which comprise bipolar plates and/or membrane-electrode assemblies, alternately or in turns, until a correspondingly required number of cells is reached, by gripping, transporting, positioning and placing them on top of one other or on edge components. In this context, end plates are referred to as edge components which form the end of the repeating units connected in series or the individual cell layers created by this.

Further components that may be required for the fuel cell stack to function can be integrated into these end plates. For example, the further components can be current collectors and/or unipolar plates and/or pressure distribution plates.

While pick-and-place systems do ensure that the repeating components are permanently guided by grippers, they are not suitable for large-scale production with regard to the requirements for a reduction in cycle time. Alternative systems for stack formation without grippers require devices for the defined alignment and positioning of the cell components.

A device and a method for positioning repeating components to be placed on top of one another for a battery or fuel cell stack are known from EP21197541 A1. In this case, the device for aligning the components consists of a vibrating jaw that can be caused to vibrate by means of a vibration generator and a rigid positioning jaw arranged thereunder. The vibrating and positioning jaws each have contact surfaces for contact with an edge of the repeating component to be placed. The vibrating jaw that can be caused to vibrate is used to center the repeating component to be placed by vibration, while the at least one positioning jaw holds the components in position in the continuous stacking process. The disadvantage of this is that the vibrating and positioning jaws are rigid and therefore, due to the non-yielding nature of the jaws, damage to the components when they hit the contact surfaces of the jaws cannot be completely ruled out. In addition, the vibrating jaws with vibration generators require a lot of space at the stacking location and a great deal of conversion work is required to adapt the jaws and the vibration elements when, for example, the components are changed to a different format or material.

### SUMMARY OF THE INVENTION

Accordingly, the invention is based on the problem of providing a device and a method that remove the disadvantages mentioned above by adapting the positioning device and method to the properties of the repeating components and allowing both an even more damage-free alignment of the components and a simplified adaptation to component changes.

This problem may be solved by a positioning device with the features of one or more embodiments herein and by a stacking device with the features of one or more embodiments herein and an associated stacking method with the features of one or more embodiments herein.

The invention provides a positioning device for positioning repeating components of a cell stack for battery cells or fuel cells that are to be placed on top of one another. In the production of fuel cells, these are in particular membrane-electrode assemblies (also referred to as MEAs) and bipolar plates (BPPs). In battery cell production, these are in particular electrodes (anode or cathode) and separators. The individual repeating components can also consist of a composite of these components; for battery cell production, a repeating component can also consist, for example, of a prefabricated stack of electrodes and separators. To form a stack from these components, the repeating components are inserted into the positioning device, aligned by it and held in their position and orientation within a stacking device. The components can be inserted into the positioning device, for example, transversely to the plane of the repeating components that are already in the stack.

The positioning device according to the invention comprises a base plate having a recess for the repeating components to pass through, at least one elastic element which is attached to the base plate and configured to decelerate a repeating component inserted into the positioning device transversely to the plane of the recess, several positioning elements which are arranged along the circumference of the recess and are configured to align a repeating component to be passed through the recess. The positioning elements are attached to a respective vibration generator, which vibration generators are fastened to the base plate. The positioning elements can be caused to vibrate by the respective vibration generator.

This means that the at least one elastic element decelerates the repeating component if, when the latter is inserted into the positioning device transversely to the plane of the repeating components, one edge of the inserted repeating component strikes the at least one elastic element. The elastic element is elastically deformable in such a way that damage to the edge of the inserted repeating component can be prevented. The material and the geometry of the elastic element are designed to yield and to dampen the impact of the repeating component on the element. The kinetic energy of the inserted repeating component is reduced, thus preventing damage to the repeating component.

Each positioning element can be caused to vibrate by a respective vibration generator, wherein, in particular, the vibration generators are individually controllable in order to generate vibration frequencies which are different from the other vibration generators. This allows the repeating components to be aligned at several edge regions by the positioning elements, while the different frequencies enable flexible adaptation of the positioning to the properties of the repeating components.

The positioning elements can be caused to vibrate by the vibration generators in such a way that the at least one edge of the inserted repeating component is aligned with the corresponding edges of the repeating components already inserted.

According to a further aspect, the invention provides a stacking device for forming a cell stack for a battery cell or fuel cell from repeating components to be placed on top of one another, the stacking device comprising at least one positioning device according to the above-described configuration and a receptacle including supporting means movable in the height direction, for supporting and for height adjustment of the cell stack during.

Due to the possibility of arranging the base plate with the positioning elements and vibration generators that are fixed on the base plate (and are not connected to the stacking device) above the stacking device and detaching it from the stacking device, the stacking device can be removed from the stacking position in order to carry out further process steps in the cell stack formation, such as pressing the stack, or to be able to use the stacking device as a workpiece carrier for the cell stack in the further process.

According to a further aspect, the invention provides a stacking method for forming a cell stack for a battery cell or fuel cell from several repeating components to be placed on top of one another, the method comprising:
a) providing a stacking device according to the above-described configuration
b) placing a repeating component
c) centering the repeating components by vibrating the vibrating jaw to bring them in contact with the positioning jaw contact surface
e) repeating steps a) through c) with additional repeating components to form the cell stack.

Preferably, the stacking method comprises the step to be performed after step c):
d) lowering the supporting means, wherein in step e), the steps a) through d) are repeated for all other repeating components.

According to one embodiment, the at least one elastic element is designed as a lamellar curved damper. On the impact of the repeating component on the at least one lamellar curved damper, the latter is dented, i.e. elastically deformed, and thus dampens the impact of the repeating component. Damage to the repeating component, in particular in the region where the edge hits the damper, can thus be avoided.

According to one embodiment, the positioning device comprises several elastic elements arranged next to each other along a lateral edge of the recess. In this way, the several elastic elements arranged next to each other form a larger area that serves to decelerate the repeating components to be inserted. As a result, the impact force with which the repeating component hits the elastic elements can be distributed to many elements, reducing the force per elastic element. It can also be said that such an arrangement of the elastic elements helps to distribute the impact force to a larger area and thus reduce the force acting on the repeating component at one point. This can further reduce the risk of damage to the repeating component caused by the insertion of the positioning device.

According to one embodiment, the radius of curvature of the at least one lamellar curved damper can be changed by means of an adjustment device. In particular, the adjustment device can be adjusted or set in a substantially vertical direction (normal direction of the base plate) and a direction perpendicular thereto, i.e. a horizontal direction (direction parallel to the surface of the base plate). The at least one damper is attached to the base plate at one end of its curved shape and is connected to the adjustment device at the other end, so that an adjustment of the adjustment device in the vertical and/or horizontal direction leads to a change in the curvature of its curved shape.

According to one embodiment, the positioning elements each have a plate-like vibrating part and a finger-like positioning part, which are integrally formed with one another as one piece. The plate-like vibrating part is connected to the vibration generator and has a sufficiently large surface area to easily transmit the vibrations generated by the vibration generator to it. Due to the integral one-piece design of the plate-like vibrating part and the finger-like positioning part, these vibrations are transmitted from the vibrating part to the positioning part so that the entire positioning element vibrates.

According to one embodiment, the plate-like vibrating part is coupled to the vibration generator and the finger-like positioning part is bent at an angle of approximately (+/−10%) 90° from the vibrating part, with the positioning part protruding at least partially into the recess. This flat design of the vibrating part makes it possible to easily transmit the vibrations generated by the vibration generator to the positioning element. The finger-like positioning part, which protrudes into the recess and projects upwards (i.e. against the stacking direction) when viewed in a stacking direction of the repeating components, makes it possible to at least pre-align the repeating components above the recess and thus reduce the risk of the repeating component tilting in the recess, e.g. by inserting the repeating component at an angle. This allows the repeating component to be guided through the recess by the positioning elements from above the recess.

According to one embodiment, the vibration generators have a vibration generator body and a fixing element, wherein the vibration generator body is accommodated in the fixing element and the fixing element is attached to the base plate. In particular, the fixing element is made up of several parts and is designed to clamp the vibration body. Thus, the vibration generator body can be fixed to the base plate at a predetermined position via the fixing element without impairing or negatively influencing the vibration properties of the vibration generating body.

In one embodiment of the positioning device according to the invention, at least one positioning element is at the same time designed as the at least one elastic element. The positioning element can be controlled by the vibration generator which sets the positioning element in vibration by which the inserted repeating component is aligned with the edges of the repeating components already inserted. At the same time, the positioning element is of elastic configuration so that the impulse of the inserted repeating component can be reduced. Thus the alignment of the repeating components by means of vibration and impulse reduction can be achieved by a single component of the device. The positioning device can thus be used for both an operation in which the repeating components are aligned by means of vibrations generated by a vibration generator and an operation in which an alignment takes place merely as a result of the resilience of the elastic elements.

In a further embodiment of the positioning device according to the invention, the at least one positioning element is designed and/or the vibration generator is controllable in such a way that the at least one positioning element does not vibrate into the envelope of the stacking device at maximum deflection. In order not to obstruct the feed of the repeating components inserted perpendicular to the stack into the stacking device, the positioning elements must not come into contact with them, even in the vibrating state. The geometry and material of the positioning element is therefore designed in such a way that the latter does not enter the trajectory of the vertically inserted repeating components when excited to vibrate. Alternatively, the vibration generator can also be controlled in such a way that the generated maximum deflection of the positioning element does not cause it to vibrate into the feed path of the repeating component.

In a further embodiment of the positioning device according to the invention, at least one elastic element and/or one positioning element has a geometry which is different from the other elastic elements or positioning elements. Thus the impulse of the inserted repeating components can be reduced at several locations and, in addition, various geometries can be used for various edge regions of the repeating components to respond in a flexible manner to the properties of the repeating components. This always allows using the optimum resilience of the elastic elements for the respective region of the repeating component. An adaptation to a repeating component with changed properties can be carried out cost-effectively by replacing the positioning elements or the elastic elements with corresponding elements with adapted geometry or adapted material.

In a further embodiment of the positioning device according to the invention, a protective element is arranged in a gap between the stacking device and the base plate to prevent repeating components from tilting. This prevents the repeating component from entering the gap between the base plate and the stacking device. Several protective elements can also be arranged, for example, next to a positioning element or an elastic element. The gap between the stacking device and the base plate can be caused by the installation space. The protective element is designed in particular as a rod-like or finger-like elongated element which is attached to the base plate or to the vibration generator or to the positioning element and extends in the vertical direction (normal direction of the base plate) from the recess in the stacking direction of the repeating components downwards (i.e. in the stacking direction), in particular beyond the recess.

In a further embodiment of the positioning device according to the invention, at least one vibration generator is configured to cause the respective positioning element to vibrate, in which case the vibration corresponds to the natural frequency of the positioning element. Accordingly, one can also say that at least one positioning element can be set in vibration by the respective vibration generators in such a way that it vibrates at its natural frequency. In this manner, comparatively large vibration amplitudes can be generated with a small vibration generator, so that the installation space required by the vibration mechanism is small.

### BRIEF DESCRIPTION OF THE DRAWINGS

Some exemplary embodiments of the invention are described in more detail below with reference to the attached drawings.

FIG. 1 shows a stacking device according to the invention in a schematic lateral view;

FIG. 2 shows a configuration of the positioning device for arrangement above the stacking device;

FIG. 3 shows a configuration of the base plate for arrangement above the stacking device in which the positioning elements are at the same time designed as an elastic element.

### DETAILED DESCRIPTION OF THE PREFERRED EMBODIMENTS

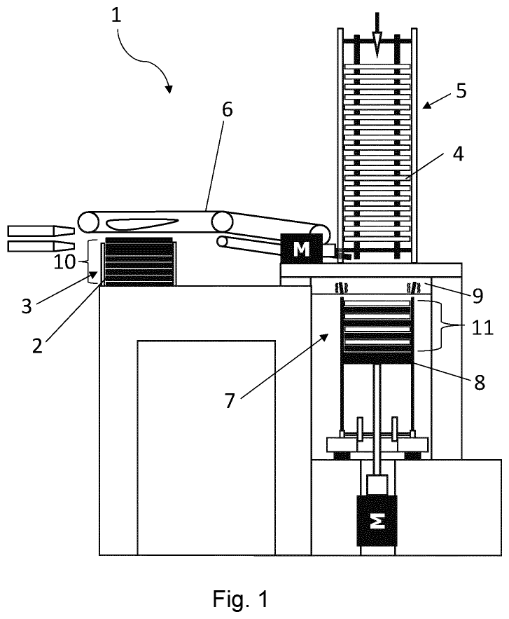

FIG. 1 shows a schematic side view of a manufacturing device 1 according to the invention. First repeating components 2, in the present example membrane-electrode arrangements of a fuel cell, are arranged in a stack 10 in a magazine-shaped repeating component supply device 3. Second repeating components 4, in the present example bipolar plates for a fuel cell, are provided in a destacking device 5 (in the illustrated embodiment a gravity magazine). The first repeating components 2 are singulated and transported to a stacking device 7 by means of a conveyor device 6, in this case a vacuum overhead conveyor belt, and inserted laterally into the stacking device. The second repeating components 4 are fed individually from the destacking device 5 to the stacking device 7 from above. The first and second repeating components 2, 4 are placed alternately on top of one another in the stacking device 7 and thus stacked to form a fuel cell stack. For this purpose, the stacking table 8 of the stacking device 7 is designed to be vertically movable and moves successively downwards during the stacking process. At the end of the stacking process, the stack 11 is removed from the stacking device 7 and further manufacturing steps are carried out to produce a fuel cell stack. In principle, the device shown can also be used to manufacture battery cells, in which case separators and electrodes are alternately stacked on top of one another instead of membrane-electrode arrangements and bipolar plates. It is also possible to stack prefabricated stacks, for example consisting of electrodes and separators, which together form a repeating component.

The repeating components are aligned in a positioning device 9, for placement in the stacking device. The positioning device 9 is arranged above the stacking device 7. In the positioning device 9, the first repeating components 2 transported from the conveyor device to the stacking device are decelerated and aligned with the stack 11.

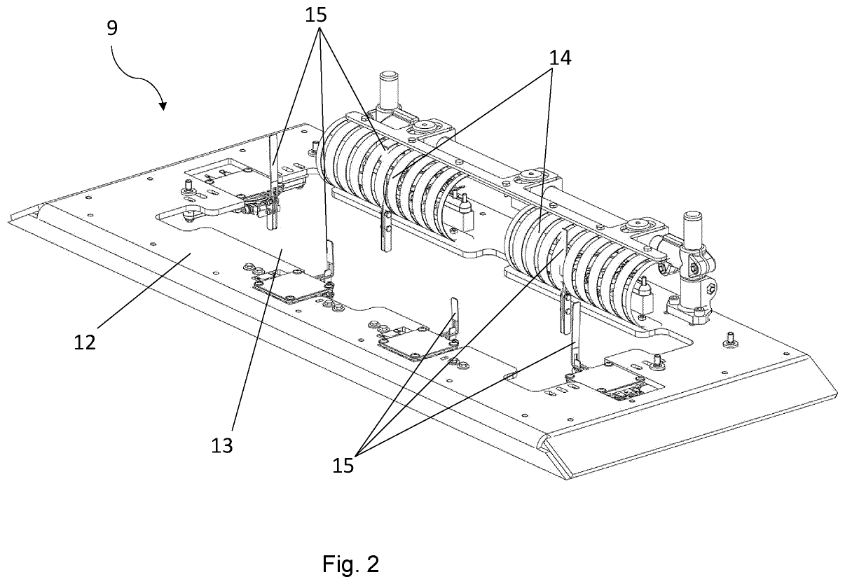

FIG. 2 shows a possible configuration of the positioning device 9. A base plate 12 for arrangement above the stacking device 7 has a recess 13 which is positioned above the stacking device 7 and whose dimensions are adapted to the size of the repeating components 2, 4 in order to allow the repeating components 2, 4 to pass through. Elastic elements 14 are attached to the base plate 12, which elastic elements, in the present embodiment, are designed as lamellar curved dampers made of a material with elastic properties; materials such as rubber or thermoplastic polyamide elastomers (TPA) can be used for example. When the repeating component 2 is fed laterally from the conveyor device 6 into the positioning device 9, it strikes at least one of the elastic elements 14 with one edge, and the elastic elements decelerate the repeating component 2 due to their yielding properties without damaging it. Upon impact of the repeating component 2, the elastic lamellae of the elastic elements 14 are dented and thus dampen the impact of the repeating component 2.

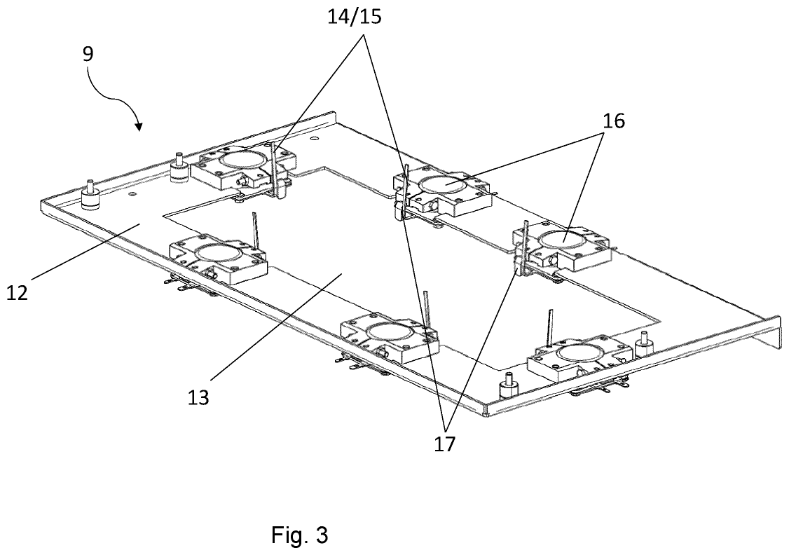

Furthermore, positioning elements 15 are attached to the base plate 12, which positioning elements are designed in this case as thin metal sheets. Vibration generators 16 (FIG. 3) are attached to the positioning elements 15, which vibration generators cause the positioning elements 15 to vibrate. If the repeating component 2 touches one or more of the positioning elements 15, it is guided to the recess 13 in the base plate by their vibration. Due to the circumferential arrangement of the positioning elements 15 around the recess 13, the repeating component 2 is centered by the positioning elements 15 and placed on the stack 11.

FIG. 3 shows another possible configuration of the positioning device 9 in which the positioning elements 15 simultaneously constitute the elastic elements 14. The positioning elements 15 are attached to the base plate 12 and are designed as thin metal sheets in the present embodiment. The thin metal sheets are yielding and are therefore suitable for decelerating the repeating components 2. When the repeating component 2 is introduced from the direction of conveyance 6 laterally into the positioning device 9, it hits at least one of the positioning elements/elastic elements 15 which, due to their elastic properties, decelerate the repeating component 2 without damaging it. Furthermore, in this embodiment, each positioning element 15 is equipped with a vibration generator 16 that can be controlled in such a way that it can cause the positioning element 15 to vibrate. The vibration of the positioning elements 15 aligns the repeating component which is then placed on the stack 11.

The positioning elements 15 also have protective elements 17 that are located in a gap between the stacking device 7 and the base plate 12 and prevent the repeating components 2, 4 from tilting in the gap.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1-11. (canceled)

12. A device for positioning repeating components of a cell stack for battery cells or fuel cells, wherein repeating components are placed on top of one another, the device comprising:
a base plate having a recess for repeating components to pass through;
at least one elastic element fastened to the base plate and configured to decelerate a repeating component inserted into the device transversely to a plane of the recess;
several positioning elements arranged along a circumference of the recess and configured to align a repeating component passed through the recess;
wherein the positioning elements are each attached to a respective vibration generator, each of which is fastened to the base plate; and
wherein each positioning element is vibrated by a respective vibration generator.

13. The device according to claim 12, wherein the at least one elastic element is a lamellar curved damper.

14. The device according to claim 13, wherein the a radius of curvature of the lamellar curved damper is configured to be changed by an adjusting device.

15. The device according to claim 12, wherein the at least one elastic element comprises several elastic elements arranged next to each other along a lateral edge of the recess.

16. The device according to claim 12, wherein the positioning elements each have a vibrating part and a positioning part which are integrally formed with one another as one piece.

17. The device according to claim 16, wherein the vibrating part is coupled to the respective vibration generator and the positioning part is bent at an angle of approximately 90° from the vibrating part, with the positioning part protruding at least partially into the recess.

18. The device according to claim 12, wherein the vibration generator comprises a vibration generator body and a fixing element, wherein the vibration generator body is accommodated in the fixing element and the fixing element is attached to the base plate.

19. The device according to claim 12, wherein the vibration generators are controllable individually.

20. The device according to claim 12, wherein at least one elastic element has a geometry which is different from other elastic elements, or
wherein one positioning element has a geometry which is different from other positioning elements, or
both.

21. The device according to claim 12, wherein at least one vibration generator is configured to cause the respective positioning element to vibrate, a vibration corresponding to a natural frequency of the positioning element.

22. A stacking device for forming a cell stack for a battery cell or fuel cell from repeating components placed on top of one another, comprising:
the device according to claim 12; and
a receptacle that includes supporting means configured to move in a height direction, for supporting and height-adjustment of the cell stack during stacking.

23. A method for forming a cell stack for a battery cell or fuel cell from several repeating components placed on top of one another, the method comprising:
a) providing the stacking device according to claim 22;
b) placing a repeating component;
c) centering the repeating component by vibrating the at least one positioning element in order to align said repeating component with edges of repeating components already placed; and,
e) repeating steps a) through c) with additional repeating components to thus form the cell stack.

24. The method according to claim 23, further comprising, to be performed after step c):
d) lowering the supporting means,
wherein in step e), the steps a) through c) are repeated for all other repeating components.
